(19) United States
(12) Patent Application Publication
(10) Pub. No.: US 2008/0201227 A1
(43) Pub. Date: Aug. 21, 2008

(54) Interactive, Internet-based, trip planning, travel resource, travel community, virtual travel, travel-based education, travel-related gaming and virtual/live tour system, methods, and processes, emphasizing a user's ability to tailor complete travel, trip, route, game and touring choices to unique user-specified personal interests, preferences, and special requirements for self and companions

(76) Inventors: Lucia Urban Bakewell, Earlysville, VA (US); Charles Adams Bakewell, Earlysville, VA (US)

Correspondence Address: Charles A. Bakewell, 1070 Earlysville Forest Dr, Earlysville, VA, 22936, US

(21) Appl. No.: 11/983,107

(22) Filed: Nov. 7, 2007

Related U.S. Application Data
(60) Provisional application No. 60/857,274, filed on Nov. 7, 2006.

(51) Int. Cl. G06Q 30/00; G06F 17/30

(52) U.S. Cl. 705/14

(57) ABSTRACT

Interactive, Internet-based, Trip Planning, Travel Resource, Travel Community, Virtual Travel, Travel-based Education, Travel-related Gaming and Virtual/Live Tour System, Methods, and Processes, emphasizing a user's ability to tailor complete travel, trip, route, and touring choices to unique, user-specified personal interests, preferences, and special requirements for self and companions throughout a particular trip or for gaming or virtual (including live, passive, interactive, individual, group, and scheduled, reserved or on-demand) tours, and including methods and processes related to scheduling games, tours, site visits and other travel-events, making related reservations and obtaining confirmations and e-tickets, and on-line banking services to process ticket, membership and merchandise payments and advertising, reservation and ticket and merchandise transactions for vendors.

### CROSS-REFERENCE TO RELATED APPLICATIONS

Provisional application No. 60/857,274, filed on Nov. 7, 2006

### STATEMENT REGARDING FEDERALLY SPONSORED RESEARCH OR DEVELOPMENT

Not applicable

### BACKGROUND OF THE INVENTION

The current invention is designed to greatly increase the satisfaction of people in planning, experiencing and recalling trips, travels and travel sites whether through virtual or actual travel or game-based adventures or educational tours.

Various forms of assistance are available to help people plan trips and travel. The assistance includes services that help a person get from place A to place B, make carrier reservations, and select and book lodging accommodations. There are travel magazine, tour books, tour packages, guidebooks, travel books, and travel and tourism promotional materials, and more!

Generally, each resource takes a particular, somewhat narrow approach and leaves the prospective traveler with the cumbersome task of integrating information of multiple types about a variety of travel sites, opportunities, and potential arrangements from multiple sources with personal with personal needs and preferences and sequencing. Further, the available print and Internet-based information generally focuses on a fairly limited range of geographic destinations and narrow areas or topics or a single interest; yet most travelers have multiple interests and want to be aware of all the possibilities as they contemplate alternative trips. Some books, periodicals or web sites address themes or subjects such as antique malls or flea markets or outlets or U.S. parks or State parks or State historical sites or cities or restaurants or the civil war or gardening or hiking or golf or NASCAR. However, they too are narrowly focused and leave a lot of work to be done by the traveler in locating, filtering, assembling, and integrating separate elements into a complete travel plan, experience or trip.

Most people have multiple interests, and family trips definitely require consideration of multiple themes, site-types, characteristics, and media to satisfy adults, children, relatives and friends. However, all the information available for planning is fragmented and not integrated and is very difficult to restructure into personal, individualized trips of any type, be they day-long or overnight or interstate actual trips or fantasy travels or game-based excursions and visits.

The word “itinerary” has come to mostly mean a set of commercial carrier reservations for a trip with possible additions of rental cars and lodging arrangements. Such trips typically are defined in terms of a starting point and one or more destinations or transfer points with traveler choices made on the basis of speed, distance, price, and airplane and/or train changes/stopovers, but not what the traveler will do or might wish to do on the trip.

Examples of Internet services which are designed to facilitate the planning of itinerary's include MapQuest, MapPoint, Orbitz, Priceline, Travelocity, the various airline and Amtrak websites, frequent flier websites, rental car companies, hotel chains, motel chains, the National Park Service, Disney, Six Flags, theme parks, state tourism sites, city directories, Chamber of Commerce directories, and on-line versions of travel magazines. The respective databases' content is narrowly constrained/defined, which limits their usefulness and attractiveness to relatively narrow albeit important tasks. If one chooses to attempt to plan a trip via search engines such as Google, the search results are essentially so extensive and unmanageable that they are frustrating, almost useless, and collectively unenjoyable, making the travel planning and touring experience the opposite of what it should be.

Some available services can help travelers determine how to get from point A to Point B and, to some extent, where to stay when they get to point B, some ideas of what to do, and where to dine. What is lacking is any assistance in identifying all the possibilities in an area or within a certain distance of a general route that would potentially satisfy the interests and desires and requirements and special needs of one or more travelers or a traveling party which have been input by the traveler(s) for screening/filtering the data. Also, there is no available online capability for sequencing trips tailored to multiple personal themes, interests, preferences, needs, and destination operating schedules and hours. Further, there is no facility for centralized access to and promotion and delivery of virtual tours and game-based travel experiences and site-related education.

Internet use for planning/booking travel/accommodations is extensive, competitive and growing fast. However, the online services focus mainly on air travel, scheduled commercial transportation services and related reservations and ticket purchases, vacation packages and promotions, accommodations, car rentals, and big name destinations and promotions, but with only some travel planning assistance and relatively limited access to thematic travel-planning across wide geographic expanses. There is no broadly-based, online service that helps travelers identify and select the activities, attractions and experiences for travel tailored to provide the greatest pleasure before and during the trip while meeting all the traveler's (or travelers' or travel group's) preferences and requirements. Books, magazines, and auto clubs fail to provide a comprehensive, easily accessed and manipulable set of data travel information that is anywhere near sufficient and convenient for the purpose. This may be because the information is too vast for treatment within their conventional methods, approaches and media or because their business models exclude large portions of the travel industry and travel sites that are of interest to travelers. Traditional approaches and sunk investments prevent them from serving the traveler with comprehensive, new systems, methods, and processes.

Further, a travel planner cannot go to a single source that identifies all the road construction sites/details along the entire length of a US route or an Interstate highway. Such information is available within each state or within a county or highway district as in Pennsylvania and Oklahoma—very user-unfriendly for travelers who will cross state lines on major highways.

What is needed is a unique process that matches all the interests, desires, requirements, and special needs of the traveler to a universal database that contains descriptions and details of all possible sites and generates a list of the matching search results for selection/rejection editing by the traveler and makes possible the arrangement of the selected sites into preferred order and then the analysis and evaluation of the resulting trip plan in terms of satisfaction, cost of travel and admissions and meals and lodging and shopping, its duration and each budgeted category of expenditure such as for antiques, flea markets, the outlet stores, amusements, the theater, and other interest-related purchases and spur of the moment acquisitions. The system also should provide highway construction information for the full length of each highway or route and help users identify the electronic and telephonic information sources along their chosen trip roadways.

Systems and methods and processes also are need for providing virtual tours and related game-based experiences, for scheduling tours and processing tour reservations and ticket sales, for processing and maintaining the respective vendor's sales revenues and sales details along with bank balances (including vendor deposits and withdrawals), for reporting summary sales and balance information, for allowing vendor query and download of the sales and account data and details, for controlling tour admission, for calculating and deducting sales commissions for the account of the invention operator, and for providing a virtual gathering area or lobby with arcade games and socialization opportunities for virtual travelers awaiting their respective tour(s). Of course, there also is a need for a variety of virtual tour capabilities ranging from simple slide shows to self-directed tours to automated tours to interactive tours to live guided tours, which are led by guides who may interact with the tour members who also are able to interact with the guide and even with each other.

### BRIEF SUMMARY OF INVENTION

The current invention described herein is The Interactive, Internet-based, Trip Planning, Travel Resource, Travel Community, Virtual Travel, Game-based Travel, Travel-based Education, and Virtual/Live Tour Site (and related methods and systems) which allows users and members (in both the free and the fee-paying categories) and trial guests to plan travel, take virtual and live tours, draw upon the invention's unique databases with searches reflecting the user's interests and preferences, and select or reject advertised and non-advertised (basic-listing) sites based upon data, information, images, programs, interactive systems, and digital video provided by the site or by other sources and systems with a fee-system for payments by enhanced-service users and members, virtual tourists, travel-gamers, other invention-users, and by advertisers, and a banking system for transaction tracking/reporting, account management, collection and remittance of fees (e.g., fees for tours, admissions, games, other offerings, and advertising) for the account of the respective tour site, and promotional incentives that reward educational achievements and entice virtual users to make the effort to actually visit specific physical sites after virtual exposure.

The invention indulges travelers' fantasies and needs with real and virtual travel experiences, accessed through the invention's proprietary databases, which bring together travelers, advertisers, travel sites and the universe of travel possibilities (including real, fantasy, virtual, live, and game-based travels as well as other electronically stored, search-generated information and other forms of travel experience) and travel-related, Internet-based services, resources, and facilities.

The current invention addresses gaps in current trip planning aids and will:

Provide users the opportunity to identify, input, store, recall and apply particular personal or group interests, preferences and requirements along a tentative road trip

Help in gathering and arraying all the possibilities that match traveler interests, preferences and requirements along a tentative road trip

Help users identify, align, understand, and choose among the real and virtual travel possibilities

Offer the ability to store trips in all stages of development throughout the planning and revision of each trip

Offer the ability to download or print the “final” trip plan and related details, reservations, budget, and available sidelights or contingencies in case of emergency, unexpected needs or changing weather.

Permit download of electronic files to PDAs, cell phones, Blackberries, iPods, GPS-based devices, and any other personal electronic device or information processing equipment, including those with keyboards, keypads, voice interaction, data manipulation and video input/output features.

Develop the opportunities for virtual travel and game-based learning about travel sites, using electronic media and devices which are critical to getting the attention of the electronically hooked generations and the seniors who no longer can travel physically but who are mentally alert and interested.

### BRIEF DESCRIPTION OF SEVERAL VIEWS OF THE DRAWING

The figures which provide views of this invention are:

FIG. 1: Overview of System and Processes and Methods

FIG. 2: System Equipment and Relationship of Operations Facility to Users and Travel-Related Sites

FIG. 3: Planning a Specific Trip

FIG. 4: Compilation, Presentation, and Provision of Information on Travel Conditions

FIG. 5: General Description of Travel-Related Site Database

FIG. 6: Search and Display Process

FIG. 7: Looking for Possible Places to Go or Taking a Daydreaming Trip

FIG. 8: Arranging for and Taking a Virtual Tour

FIG. 9: Virtual Tour (General Process)

FIG. 10: Virtual Tour Option Illustrations

FIG. 11: Game-Based Travel

FIG. 12: Scheduling Process and System

FIG. 13: Banking/Payment Transaction Module

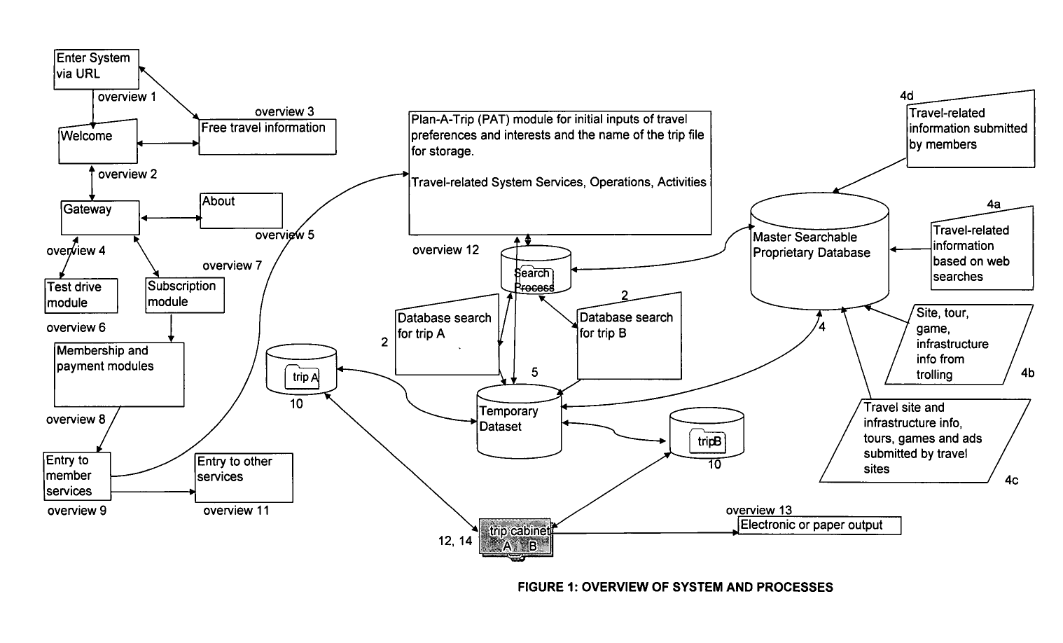

FIG. 1: Overview of System and Processes and Methods. This figure presents an overview of the systems and the processes within the system whereby users provide information inputs to the system, which are matched against database information. The matching process feeds an interactive iterative process through which the user makes choices that ultimately lead to trip plans, virtual travel, virtual and game-based travel and travel-based gaming events and experiences.

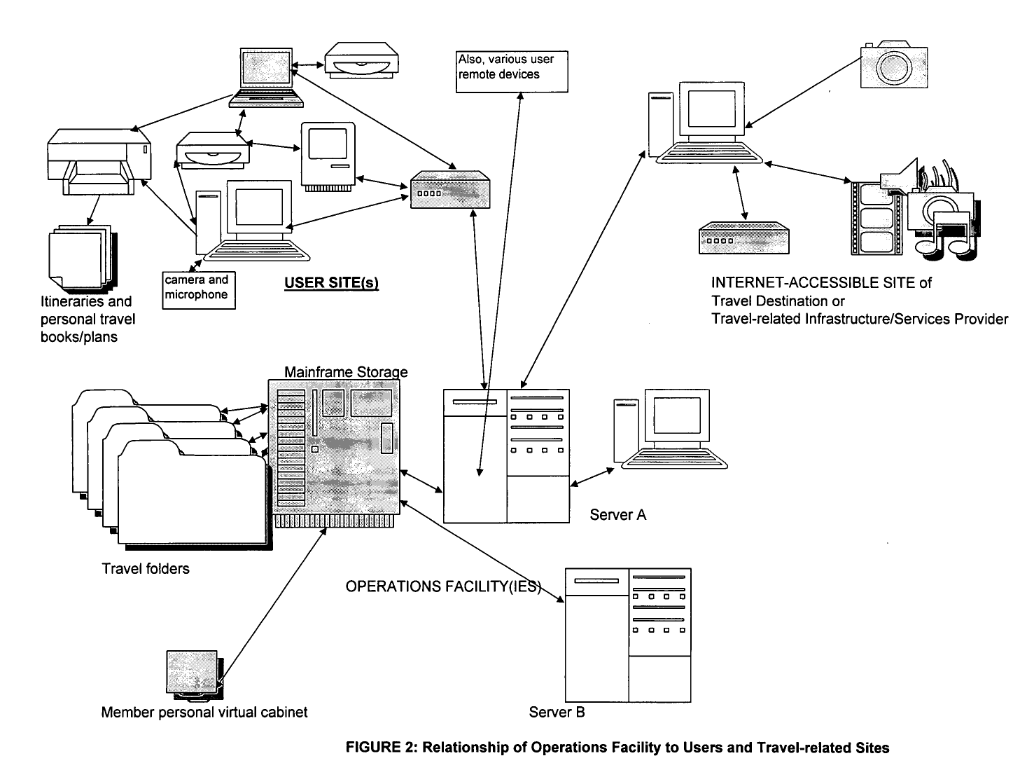

FIG. 2: Equipment and Relationship of Operations Facility to Users and Travel-Related Sites. This figure illustrates the representative operations facility upon which the invention system and processes might reside as well as the relationship of that facility to the equipment and facilities of users and at travel-related sites.

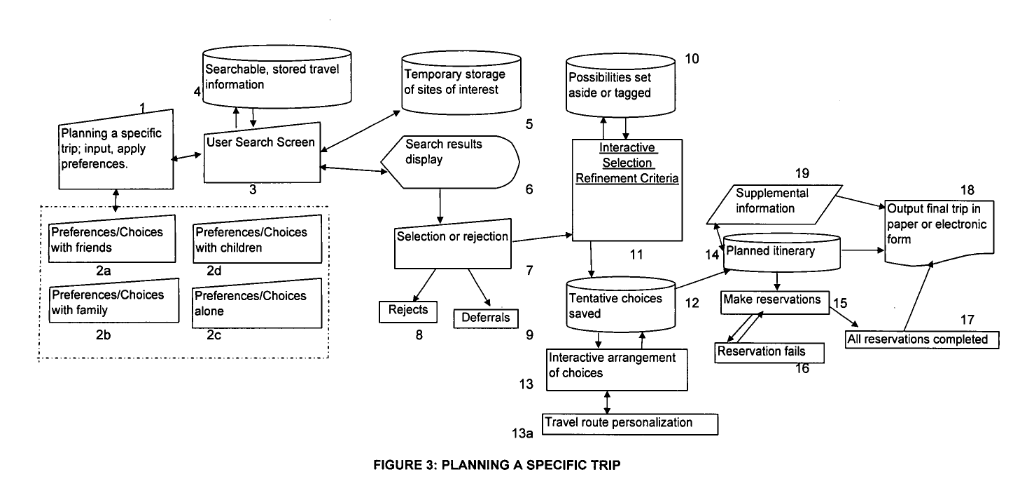

FIG. 3: Planning a Specific Trip. This figure illustrates the invention's generalized process for planning a specific trip by showing the flow of information and decisions between the user and the invention database of the universe of opportunities, and the progressive development of an itinerary that meets the user's preferences and special requirements and is optimized for time considerations, duration, budget, reservation availability and suitability, producing a complete and comprehensive trip plan on paper or in electronic form.

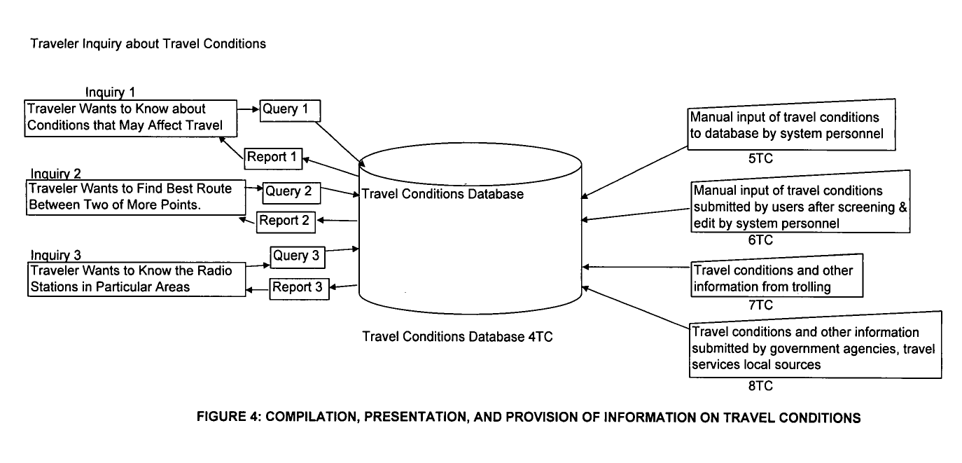

FIG. 4: Compilation, Presentation, and Provision of Information on Travel Conditions. This figure describes a traffic conditions database, its information sources, and three types of user queries.

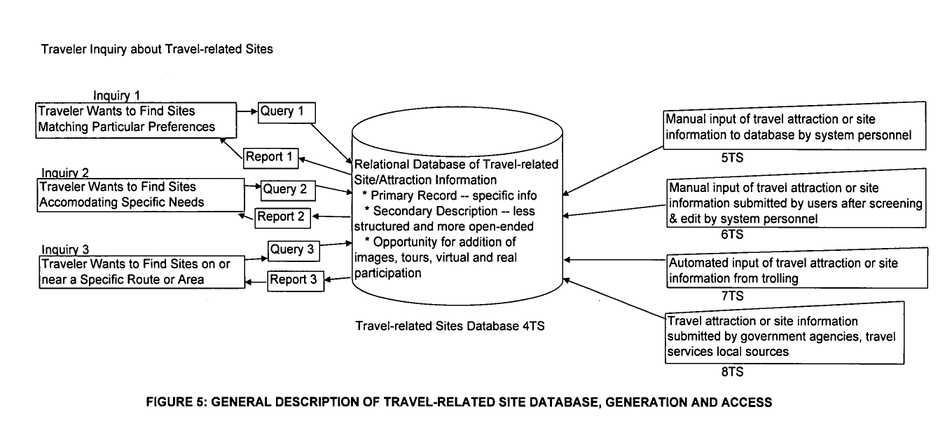

FIG. 5: General Description of Travel-Related Site Database. This figure describes the relational database content for travel destinations, the system's travel store, travel-related games, digital tours and video tours and the tours' and games' schedules and availability. It also illustrates the limitless range of keywords a user may use in an open-ended search of all text provided by vendors, advertisers, other organizations and service providers and the invention operator.

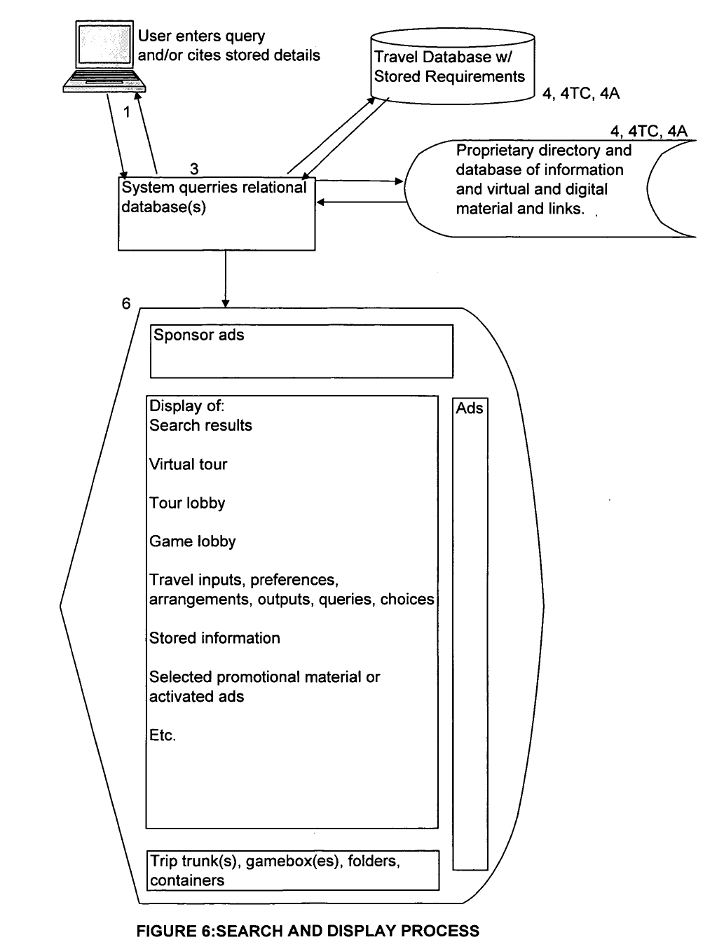

FIG. 6: Search and Display Process. This figure illustrates the user's query of the system, the display of the query results, and the user's options for storing or discarding the results and viewing keyword-based opportunities that the system has identified as likely to be of interest to the user.

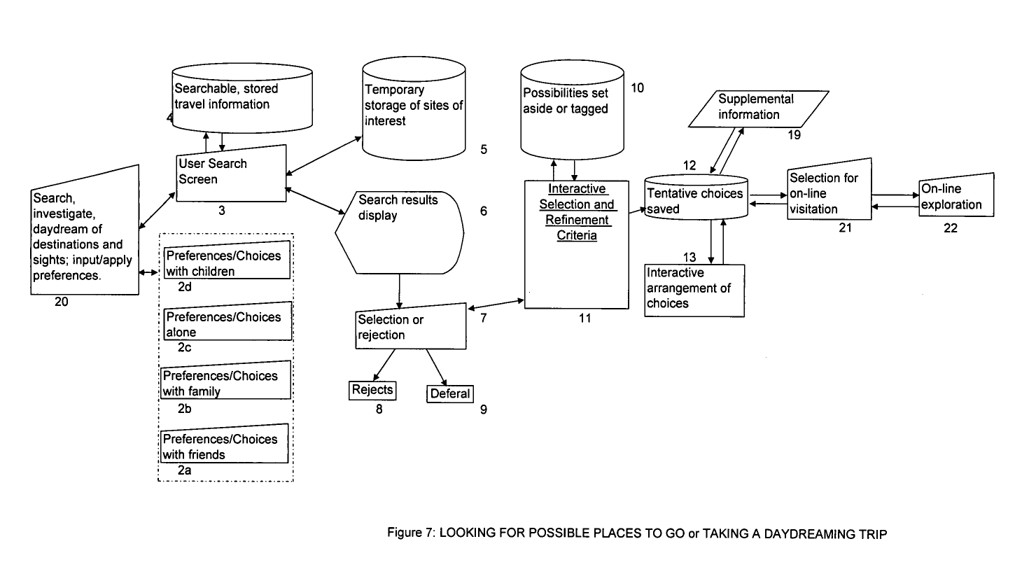

FIG. 7: Looking for Possible Places to Go or Taking a Daydreaming Trip. This figure is similar to FIG. 3 except that it illustrates a less-structured search by the user for possible places to go or for the pursuit of a serendipitous daydream or virtual trip.

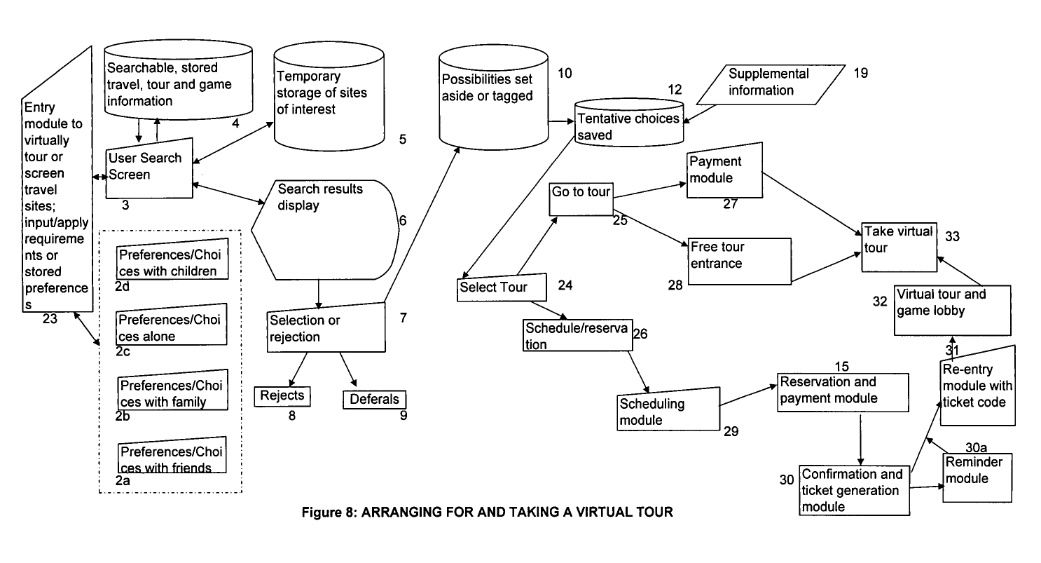

FIG. 8: Arranging for and Taking a Virtual Tour. This figure starts with the same input inquiry process used in planning a trip but the objective is to identify virtual tour options, to make a selection, to make a reservation for later return or to take the tour immediately, and to spend time in the virtual tour and gaming lobby before taking the tour.

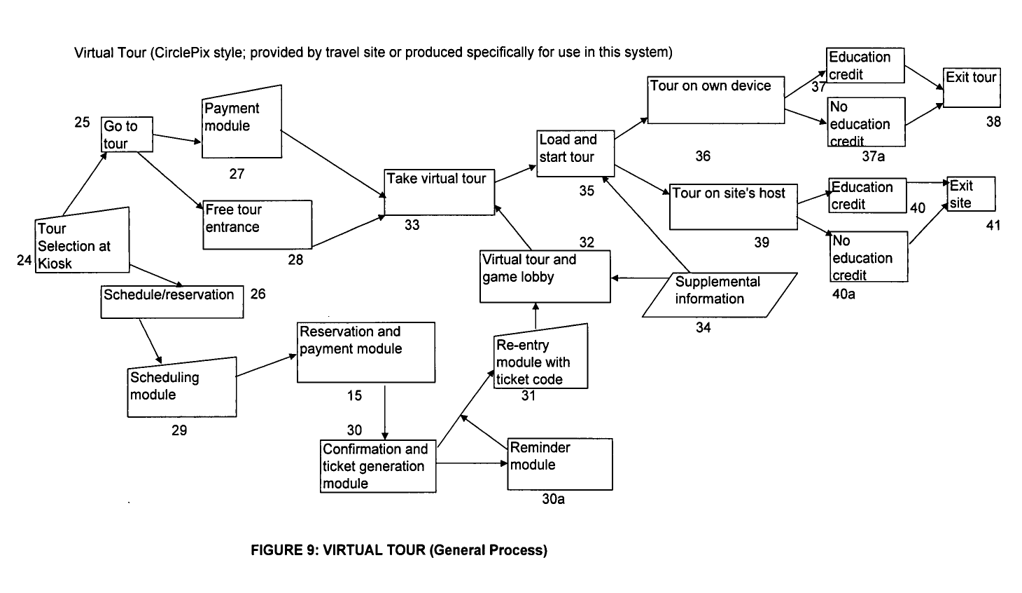

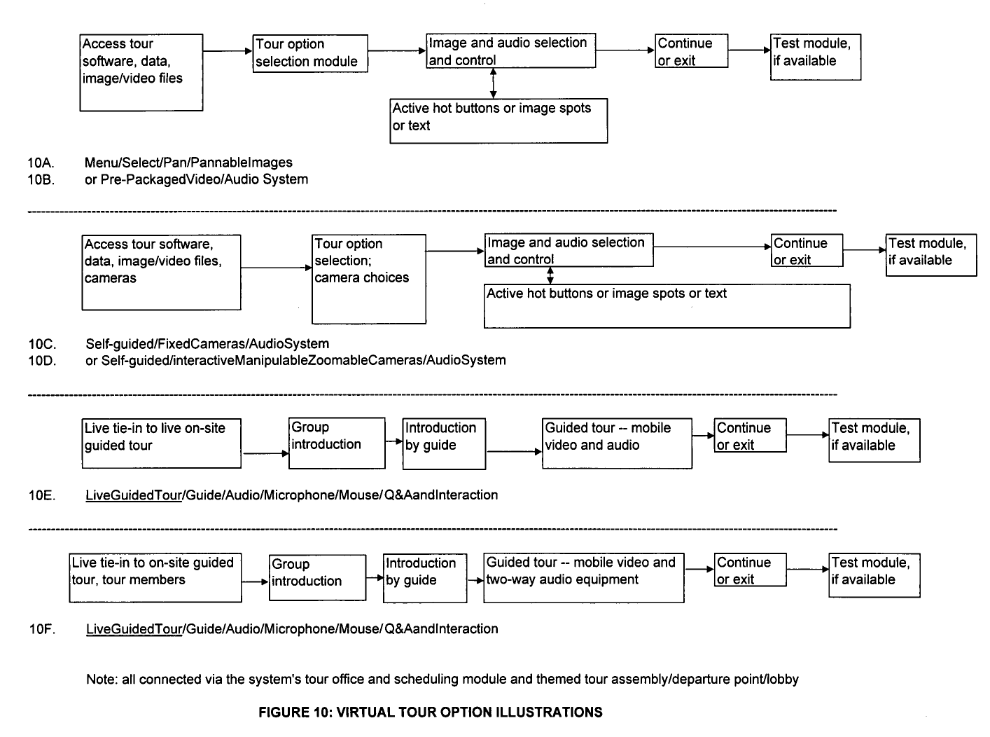

FIG. 9: Virtual Tour (General Process). This figure shows the sequence of steps once the virtual tour has been selected. The tour may be in a variety of formats, which will be illustrated in FIG. 10. This figure also shows the option at the end of the tour to take a test for education credit after which the user exits the virtual tour.

FIG. 10: Virtual Tour Option Illustrations. This figure shows a number of virtual tour formats, which are incorporated into the invention. These range from passive viewing of images with or without a narrative text or audio track through self-guided tour options to the most complex options which are guided live by a tour guide with varying degrees in interaction between the guide and the tour members and even among the tour members themselves.

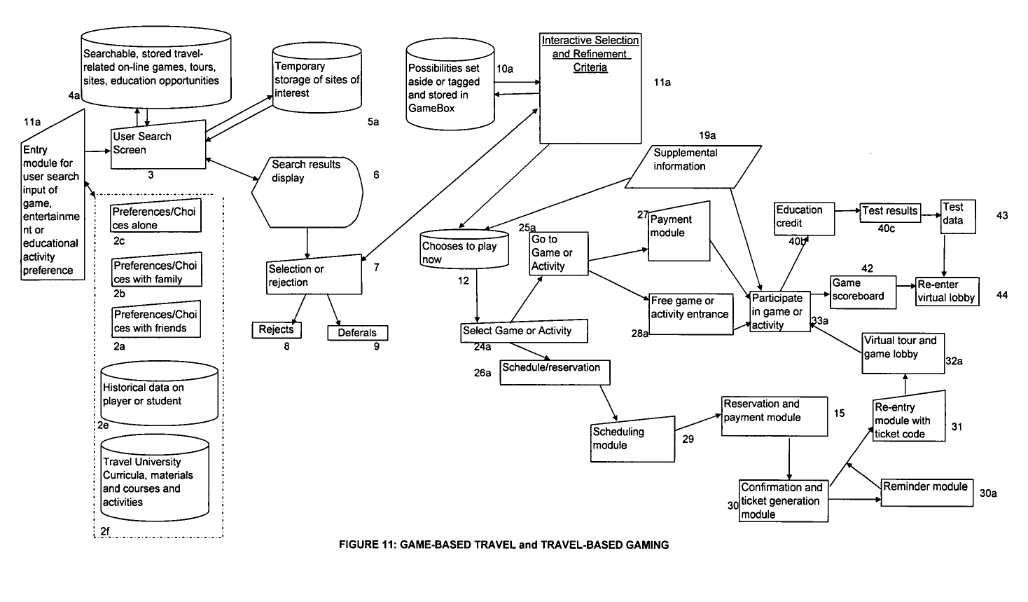

FIG. 11: Game-Based Travel. This figure builds on the trip planning model but focuses on: the game preferences of the user; the purpose for the game activity (e.g., educational, pleasure, challenge); the user's abilities, scores, preferences and sophistication as revealed by intelligent system evaluation of the player; and the curriculum of the course or program specified by a participating school or university. Once the game has been selected, the process is similar to the selection, operation, and educational testing illustrated in FIGS. 9 and 10 for virtual tours.

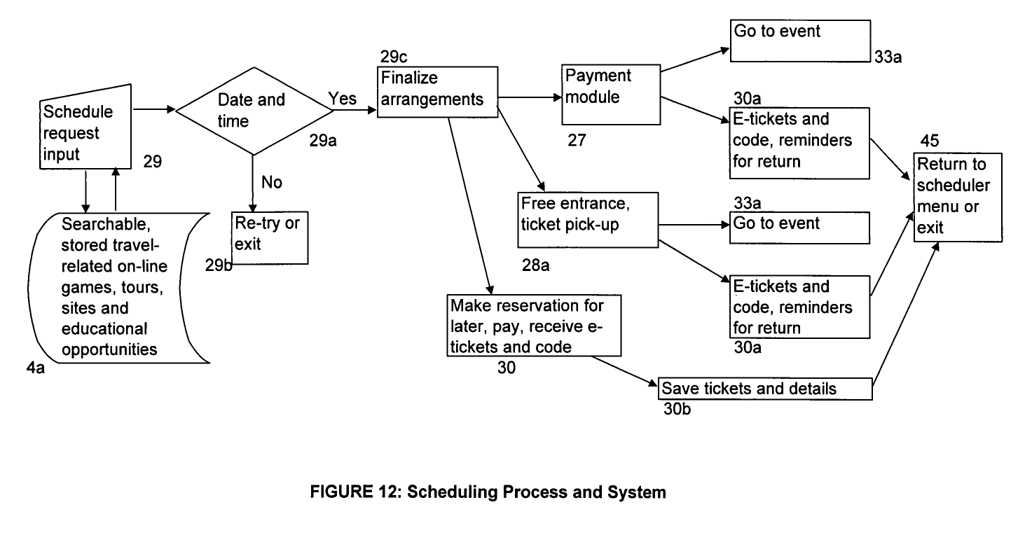

FIG. 12: Scheduling Process and System. This figure depicts the scheduling and reservation process and ticket issuance for virtual tours and games and for actual site visits for individuals and self-identified groups.

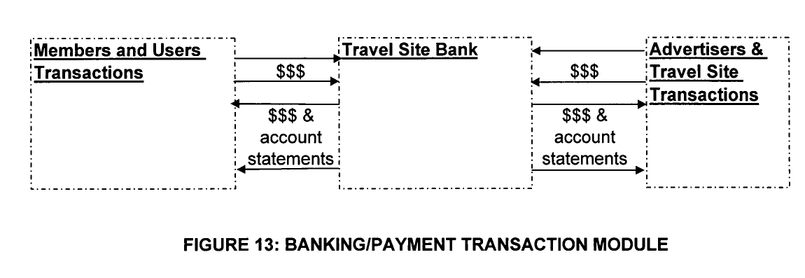

FIG. 13: Banking/Payment Transaction Module. This figure shows the operation of the banking and payment transaction module within the invention.

### DETAILED DESCRIPTION OF THE INVENTION

The current invention helps travelers find, sort through, and select the travel activities and experiences that meet their needs and pleasures, drawing from a candidate database of paid and non-paid listings of what there is to do, and interacting with other travelers, resources, and virtual material as they make their choices. Resulting trip plans are reversibly constrained by travel party inputs and preferences for special requirements, limitations, time allocations, scheduled commitments, and restrictions (e.g., disabilities). Users can start with a thematic trip in mind or tentative itinerary or any other inputs to identify/query/filter invention resources/databases for real, virtual, game-based or Internet-based or downloaded touring, traveling, gaming or educational experiences.

Users using certain enhanced services of the invention may be required to pay user fees. Advertisers/listers may choose to upgrade from a basic listing to flat-fee ads or click-based keyword-auctioned advertising fees or enhanced online presentation capabilities. Fees may be charged for some on-line tours, games, and educational programs and some other travel-related offerings/services with the revenues less commission going to the entity providing the tour or game or educational program or offering. Some of these fee-based services actually may have fees waived if the provider underwrites the offering or if paid-advertising sponsors the offering.

The core database and search capabilities are housed in secure facilities and protected with firewalls. Member and user access is by Internet; some services will be for members only, at least initially with limited free services and an opportunity for a limited free trial of the services external to the complete, members-only facilities. The proprietary database may include data, information, and travel sites, tours and services: 1) gathered by trolls, 2) submitted with application for inclusion, 3) collected by staff, and 4) from other means and sources. All entries into the databases may be filtered by staff and/or software to sanitize and/or verify the stored information.

The invention's objective is to provide for each visitor or member (paying and non-paying) great enjoyment of actual and virtual travel and travel-related experiences as a result of:
identifying and choosing among all the available places, activities, experiences, services, and opportunities between two or more locations or along particular itineraries or in variably-defined geographic areas
maximizing the pleasure in the planning phase as well as on the actual trip
satisfying personal preferences, interests, special requirements, and constraints (e.g., disabilities) that are established and entered by the invention user
printing or downloading resulting trip plans and details created by the invention user and individualized and complete for use on the trip
saving trip plans or related information in trip folders within a personalized trip trunk
saving games and travel-related games in personalized gameboxes
exchanging saved trip information and plans and ideas with other people
using messaging, blogs, and other communications methods to communicate
taking virtual and live tours online
playing travel-related games and actually seeing the travel sites or representative imagery as part of the games
learning about various travel sites for self-edification or as part of educational programs (credit or non-credit)

The systems and processes of the invention are designed to:
Provide comprehensive, integrated, truly individualized trip planning capabilities
Make the trip planning itself a pleasurable experience or satisfying fantasy
Help an individual or group plan a trip tailored to the personal special interests, preferences, needs, requirements and concerns of the individual or each member of a group
Provide access to opportunities and details that otherwise are not easily discovered, gathered and integrated
Expand the choices available by allowing searches by any keyword of a database of opportunities that use the words provided by vendors or travel sites to describe their respective site or attraction or facility or tour(s) and features, hours, special facilities and accommodations, targeted age-levels, age-restrictions, and so on
Facilitate thematic or serendipitous trip planning with a budget and no initial destinations or trip-building around a structured schedule such as a business trip
Expand traveler's virtual access to remote and interesting sites which time and cost otherwise would not permit
Entice otherwise disinterested audiences into travel and site introductions and learning experiences with the objectives of promoting the site, generating revenues for the site, building advocacy for the site, broadening awareness of the site, entertaining the broader audience, and providing educational exposure concerning various aspects of the site or the experience.

The invention system and processes will be capable of expansion to incorporate other travel-related services and offerings.

Listing and advertising fee schedules may follow a tiered structure such as a basic listing, an expanded listing, and a deluxe listing.

The invention deployed on one or more Internet sites may incorporate frame ads, which may be priced as flat-fee or may be the result of keyword-auction for which the pricing is click-based. Presentation of the ads may be via randomized combinations or preset on each search page with the displayed ads selected from the applicable categories based on algorithms favoring the higher priced advertising but ensuring exposure to the lower-priced advertisements, all selected based on keyword match.

The text-searchable elements of the relational, expandable database record of each searchable site or offering may include some or all of the following, plus others (remembering that user searches access all the descriptions for matches, not just the heading for a record element):

Primary Record: Unique Identifier ID, Category ID, Attraction Type, Primary Accommodation Type, Restaurant Type, Travel Services Type, Personal Services Available, Store Type, Travel Access Method, Business/Site Name, Street Address, Town or City, State, Zip Code, Brief Description, Telephone, Fax, E-mail address, URL

Secondary description: Attraction Type—Secondary, if any, Unique Identifier ID, Fee or rate schedule, Special rate packages, Season(s) of Service, Hours of Operation, Weekdays, Saturday, Sundays, Dates closed, Special days closed, Special closures, Age Restrictions, Special Services (e.g., handicap access), Theme Tie-Ins, Photos, Digital Videos

The system gives site operators, advertisers, and vendors the flexibility to tailor database cells, contents and links to reflect whatever features and categories of information a respective site feels are appropriate to describe its uniqueness and appeal. Examples of some of the invention system search terms (which could be used in Boolean advanced searches—essentially any term or terms one might use in any Internet search) include (but of course are not limited to): Sports, Baseball, Football, Sailing, Skiing, Hiking, Tennis, Golf, Swimming, NASCAR, Cheap Eats, Upscale Restaurants, French Cuisine, German Food, Oktoberfest, Italian Food, Greek Food, Thai Food, Chinese Food, Middle Eastern Food, Afghan Food, Lebanese Food, National Parks, State Parks, Local/City/County Parks, Public Beaches, Street Fairs, Festivals, Art Shows, Art Galleries, Arts & Crafts, Theme Parks, Hot Air Ballooning, Tours, Particular artists or performers or shows, Traffic problems, Alternate routes and detours, Rush hours and times of congestion or construction, Road conditions, Weather, Handicap access, Special medical conditions, Days of operation, States, Cities, Campgrounds, Hotels, Motels, Chains, Chain stores (Ralph Lauren, Wal-Mart, etc.), Outlet Malls, Chambers of Commerce, Antiques, Flea Markets, Book Stores, 24-hour Care, Hospitals, Tourist Sites, Amusement Parks, Ethnic Associations, Churches, Veterinarians, Concerts, Performers, History, Civil War, Re-enactments, Re-enactors, Car Rentals, Airlines, B&Bs, Gardening, Orchids, Museums, Natural History, Science, Aerospace, Industry or a particular industry or type of business, Social History, Alcatraz, and so on.

The current invention includes methods and processes (with the obvious software) to:

Register users

Provide a trial experience

Enroll users and members for fee and non-fee services and EFT (credit card, data debit card, check)

Receive and store user master profiles for trips

Retrieve and change user master profiles of:
Interests
Requirements
Preferences
Special needs for travelers and companions

Receive, store, retrieve and change unique trip profiles including:
Interest(s)
Requirements
Preferences
Special needs

Store trip profiles by trip names determined by user

Apply trip name file and/or selected profile against invention system database to identify all sites, services, facilities, etc. satisfying (matching) the respective profiles/trip file specifications

Return/present matches in a list (ordered or random) as search results with matching search terms highlighted. List may be in table format or paragraph(s) with live links to the complete, respective, database record.

Allow each match in the returns list or table to be rejected or to be saved to an intermediate or final database file for implementation as virtual, fantasy or real-life travel

Allow the user to see, via split screen or on full screen, the location of the selected sites on the political map or sky-view image or relief map or other spatial representation, all of which may be zoomable. Optionally, as each match is passed over with the cursor, the location of the site may show on the respective state map and the state may illuminate on the country map.

Allow the user to rearrange each trip's list of items into preferred order and to specify the specific hours and days to be spent at each site. The order can be viewed on a map of the route that is reordered/resequenced in real-time.

Provide capability for user to toggle individual switches to calculate/update/present various trip metrics such as road miles, fuel costs (or full costs), admissions costs, on-site expenditures, meal costs, lodging costs, amusements and entertainment costs, shopping cost estimates/budgets, etc.

Allow the user to click on a site-type icon or symbol or thumbnail image for a particular site in the listing to see database information and images and stored video (analog or digital or other) for that site and then click the button to delete the site from the trip file database or another button to save the site to the current trip database. Alternatively, the user can click and drag the site to the desired receptacle or trunk or other holder.

Click-for-fee tour portal access to site-specific tour-cam(s) (for interactive, zoomable, 360-degree or spherical interactive self-guided tour) or tour-guide (a live, interactive tour of sites via on-site cameras or stored media or cameras carried and operated by a tour-guide) with access to a tour-guide person for questions/answers. Also with access to other members of the tour for optional interaction and touring companionship.

Tour-guide service scheduled (via current invention's reservation system and method) or first-come, first-served capability to schedule tour-guide service with fee prepaid.

Provide database population capability for basic listing of sites, attractions, services, facilities, etc. of possible interest to any type (e.g., virtual or fantasy or game-based or real or other) “traveler”.

Provide an open-ended universal database population capability for fee-based additions of information elements not in the basic data base elements.

Develop and maintain a compartmentalized, secure, universal database of sites, attractions, services, facilities, etc. of possible interest to any type of traveler on a secure data storage system that permits database search and retrieval of individual matching items.

Develop and maintain secure storage of digital and analog video of site tours available free or for a fee for passive or interactive touring, such tours and material either developed within or for the current invention system or provided by a travel-related site with the links to such tour capabilities at the respective site(s).

Link tour-paid users to external or internal sites that store their respective digital or analog tour video.

Calculate click-for-fee tour revenues for each site and credit the site account maintained and held by the invention system, providing daily activity reporting to each site, and with the invention system retaining a portion of the fee for services provided.

Allow vendors (site, attraction, service, facility, etc.) to submit information for listing—basic level and fee-based increments for additional elements and data extent/complexity.

Allow vendors to pay for fee-based advertising and site-content increments by electronic pay method including credit card, electronic check, electronic funds transfer, etc.

Control and filter submitted vendor information for authenticity, acceptability (although the invention system is not responsible for content), suitability, proper placement, compliance, and receipt/clearing of fee payment(s).

Calculate click-per-view advertising, which is charged by the click against the respective vendor's advertising account which has been established with an initial deposit and secured with a valid credit card or other payment/credit arrangement and replenishment process.

Arrange and display keyword-based listings for vendors who have bought flat-fee-based advertising presentation (placement based on random selection and/or fee-ranking) and/or fee-per-click presentation (based on auction results of competitive rate-per-click bidding and/or randomization of second-tier or fractals of rate-per-click bidders).

Generate and provide advertising activity data and fee-based marketing information to vendors, respecting confidentiality of individual vendors.

Allow and support the user-downloading of a trip plan (whether intermediate or final), subject to limitations specified for the respective user or membership class, fee-level and available material, and user-optional incremental usage fees.

Require manual insertion of a server-generated unique security code to proceed with a download and provide a fee-related limitation capability to control the download file size for trip plan lists.

Provide a secure transaction capability for processing payments (credit card and electronic checks and bank check payments and electronic transfers, etc.) of account balances and fees incurred, for crediting fee-generated funds to an account (creating a positive cash balance) or to replenish an account balance, and to draw down funds collected by the invention system for virtual tours, merchandise sales, advance ticket sales, and other vendor revenues earned, net of commissions and fees due for services provided by the current invention system.

Facilitate and support the downloading of fee-based tour files with vendor-specific limitations such as key codes, automatic file self-destruction, or other methods of preventing illegal transfer/use of the respective tour file.

The ability for a user to sort trip lists by extent of match (calculated by the invention system), alphabetically, by type of site, by user interest or preference, by food or restaurant type, by location or proximity, by price, or any other sorting factor or Boolean combinations of such.

Ability to present tables of site-names and respective site characteristics/details in columns under sort-word headings.

Ability for the invention system to control the number of items returned per page and the number of sites that can be viewed or downloaded via list or trip plan or table in a single action or session or plan.

Ability for a member or user to allow another member or user to have either view-only access to a particular trip plan which may be annotated but not changed or, alternatively, to a copy of a trip plan file with a track change capability for joint planning use.

Provide an instant-messaging and forum/log capability for use of registered users or members only.

Provide an on-line travel magazine for registered users or members only.

Provide registered user or members-only contests (with each user or member having an online ballot to rank submitted entries) for: travel articles, travel photos, travel recommendations and plans.

Provide a tour-cam format for presentation of site tour parts (e.g., site map with hot spots; house with rooms; museum with galleries for category; theme park with particular attractions; historical sites with aspects to discover and explore, etc.), tour-paid user selection of what to see, user manipulation of the scene and objects within a tour part, user choice of tour technology (e.g., visual, audio, guided with hot spots, etc.), and live interaction with site and tour guide and fellow tourers.

Site tours and a game format to adapt the site offerings and tours to the population's preference for action and game-based formats and interaction with goals and scores that generate user satisfaction and increase interest in the site and site experience.

The following specific discussions of FIGS. 1 through 13 describe the invention in additional detail.

FIG. 1: Overview of System and Processes and Methods. This figure presents an overview of the systems and the processes within the system whereby users provide information inputs to the system, which are matched against database information. The database information has been provided by and extracted from various sources and includes descriptive information, imagery and interactive opportunities as well as infrastructure information. The matching process feeds an interactive, iterative process through which the user makes choices which ultimately lead to trip plans, virtual travel, virtual and game-based travel and travel-based gaming events and experiences.

The user enters the system via web URL (overview 1) and views the Welcome Page (overview 2) and selects Gateway Page or exits. The user may enter a free travel information webpage and obtain free advisory information about intended route(s) (overview 3). The Gateway Page introduces the system and the user selects from Next Page Options or exits the system. The About System page describes the system site, intent, disclaimers, limitations of user rights, copyrights, patents, and contacts. The user may select to Test Drive the system (overview 6) and arrives at a page which requests initial inputs of travel preferences and interests and the test driver's choice of a name for the file which he or she temporarily will store during the trial. The Test Drive provides limited information from the system database in a partially completed shell. The partial completion gives the user a sense of what is possible via the system.

The viewer may select to subscribe to the system (overview 7) and enters payment system (overview 8) to pay by credit card or electronic funds transfer. The user selects membership term and services and enters payment information which is processed and involves selection of a userid and password for access to member services.

To enter the system a member enters userid and password for access to the member services (overview 9). The member may enter a webpage for one of the other services offered to members (overview 11).

The member may select to Plan-A-Trip (PAT) (overview 12) and arrives at a page which requests initial inputs of travel preferences and interests and the name of the file for storage in a respective trip folder and optional application to particular trips. General Inputs identify:
Special requirements
Preferred characteristics
Special Interests
General Interests
   The PAT system facilitates selection, sequencing travel to sites or travel-related virtual touring and gaming and education, helps schedule and make reservations, operates virtual tours, provides gathering areas for garners and tourers, provides banking and ticket services for advertisers, vendors, advertisers, travelers, etc.

The heart of the system is its Master Searchable Proprietary Database of Travel-related Sites, Experiences, Virtual Tours, Games, and Infrastructure and links to external hosts that provide more of the same for their respective sites, tours, games, and travel-related experiences and opportunities. The database information is developed by:
Manual input of travel-related site, tour, game and infrastructure information submitted by members to database after screening/edit by system personnel
Manual input of travel-related site, tour, game and infrastructure information to database by system personnel based on web searches
Travel-related site, tour, game and infrastructure info from trolling by the system
Travel site and infrastructure info, tours, games and ads submitted by travel sites, screened by system personnel, and inserted into the system
   The PAT search and selection processes generate Trip Plans which are stored for revision, sharing or use. The electronic or paper output (overview 13) includes plans, reservations, e-tickets, itineraries and supplementary descriptive information about sites, infrastructure, alternatives, etc.

FIG. 2: Equipment and Relationship of Operations Facility to Users and Travel-Related Sites. This figure illustrates the representative operations facility upon which the system and processes might reside and the relationship of that facility to the equipment and facilities of users and at travel-related sites. The user site primarily consists of equipment for input to, review and selection, output and downloading, and participation in virtual tours and travel-related games. The systems also supports cell phones, PDAs, Blackberry-type systems, WiFi computing devices, vehicle on-board direction and mapping systems, video and audio devices, and gaming equipment.

The Internet accessible site at the travel destination or the travel-related infrastructure/services provider supports that site's submission of information about the site for the master database, the site's tracking and management of its financial account, and the management and operation of its virtual tour services. The PAT system supports remote travel site use of mixed media creative and interactive capabilities which permit live creative/interactive mixed media connectivity for tours (static or aimable/zoomable or mobile/dynamic borne by vehicle or person) with remote operation and/or on-site operation and possibly interaction with a live tour guide who operates WiFi-connected computing, video, audio, and display communications capabilities and display headset).

The PAT systems' operations facilities perform a variety of services including:

Receiving/processing/providing basic and expanded information which is submitted to the system by:
Advertisers
Travel destinations
Travel-related services providers
Travel-related infrastructure facilities

Supporting the search processes and the proprietary database

Activity scheduling

Transaction and account data for services and products bought/sold and provided through the system

Conducting, operating and linking to:

a Tours (digital)—connecting travelers to virtual tours and providing same

Maintain tour schedules and scheduling reservations

Integrated banking, payment, and transaction accounting, credit card processing, and electronic payment receipt and transfer of account balances and accountholder withdrawals and deposits

Account and transaction analyses and summaries for vendors, advertisers, travel sites, and other participants

Account and transaction management services

FIG. 3: Planning a Specific Trip. This figure illustrates the invention's generalized process for planning a specific trip by showing the flow of information and decisions between the user and the invention database of the universe of opportunities, and the progressive development of an itinerary that meets the user's preferences and special requirements and is optimized for time considerations, duration, budget, reservation availability and suitability, producing a trip plan on paper or in electronic form. The user provides inputs 1, 2 which are matched 3 against the invention's database 4 and the user selects sites of interest to store for later consideration 5 or views display search results 6 and selects items for rejection and puts them in a trash receptacle or defers them (filing them within a trip folder name) or proceeds with further consideration, applying personal selection refinement criteria 11 set by the user. The user considers the possibilities 10 or proceeds with the tentative choices 12, interactively arranging the choices and trial itinerary with travel routes and times and tentative visit times, all of which can be stored and viewed line-by-line in a daily chronology and in calendar form 13. The travel itinerary may be further optimized and personalized and refined 13a. At any stage, the tentative itinerary can be transformed into a planned itinerary 14 with all details, maps, brochures, images and video including supplemental information drawn from a master file and links 19. The user may make reservations through complementary e-services or direct 15, 16 and 17. The finalized itinerary and reservations may be on paper or in electronic form and as a download to a PC or a PDA or cell phone or other electronic device.

The invention allows the traveler to establish a personal data file 2 of interests and desires and requirements and special needs, which can be applied to all travel planning by the individual or can be turned off when planning a particular trip. In this way, the service can always alert the traveler about nearby sites of interest along a travel route in case the traveler wishes to add one of the sites not to be missed to his or her current travel plan.

The traveler can save his or her personal preference file(s) as well as preliminary, intermediate or final travel-planned inputs and service-generated and user-edited lists of sites under consideration or included in the plan. This means that the invention service will provide data storage capability for each registered user or member. Because of the cost of storage, there will be a specific amount of storage included in user and membership levels and additional increments maybe purchased. The storage will be provided for a traveler's profiles, trips' respective specific preferences and input, and trip information generated interactively with the service.

Intelligent suggestions, introducing more to do/see along and near a contemplated route will be based on stored information about an individual's general and specific interests and matches of that information against the invention's unique, searchable, comprehensive, national database. The trip-optimizer may suggest efficient ways of incorporating the additional sites in a planned trip.

Specifically, the illustrated sequence includes the following elements numbered to correspond to the figure elements:

1. Planning a specific trip; input specific preferences & special requirements with trip name for file.

2. Apply preferences on file, if desired.

3. Search for ideas by some category or particular place or interest, etc.

4. Searchable, stored information about travel sites and travel infrastructure

5. Selected sites of interest to the travel planner stored for later consideration

6. Display search results with paid ads at top and side and with special feature icons with each entry

7. Possibilities selected for consideration

8. Rejects (sent to a trash receptacle or can be knocked into or dragged into a hole with sound effects)

9. Deferrals (put on shelf or sent into a trip name folder in the user's personal trip trunk)

10. Possibilities set aside or tagged with interest/note or trip file name

11. Examples of Interactive Selection Refinement Criteria include:
Total time for trip
What to see/do at each site?
Features
Links to websites and paid ads
Access by car? train???
Time at each place?
Recommended?
Personal preference?
Preferences of others?
Places to eat/stay nearby?
Costs: see, eat, stay, travel

12. Tentative choices

13. Interactive arrangement of choices into trial itinerary with travel routes and time and allotted visit times—line-by-line and in calendar form

13a. Travel route identification, optimization, personalization, travel-time calculation and adjustment for time-of-day, day-of-week, roadwork, etc. factors

14. Planned itinerary with all details, maps, brochures, images and video

15. Make reservations through complementary eService or direct

16. Reservation not available or not good; get a replacement

17. All reservations completed, confirmations noted, travel package with all itinerary/accommodations and sites and restaurants within XXX miles of route listed.

18. Output final trip in paper or electronic form or as download to PC or PDA or cell phone or other device

19. Supplemental information drawn from master file and links which augments the itinerary information and output.

FIG. 4: Compilation, Presentation, and Provision of Information on Travel Conditions. This figure describes a traffic conditions database 4TC, which is developed from various sources and inserted manually or by trolling or by direct submission from validated sources 5TC, 6TC, 7TC, 8TC. It also shows user queries 1, 2, 3 such as wanting to know of conditions that may affect travel, what delays to expect and what alternative routes there may be, and how to stay in touch with the local area news traffic and weather as well as identifying local programming for travel entertainment.

For instance, in the FIG. 4 illustration:

1. A traveler may want to know about conditions that may affect travel: weather, road construction, strikes, infrastructure issues, fuel prices, fuel availability. Searches on locations, routes, modes, and topics of interest in planning and timing specific travel.

2. Or a traveler may want to travel between two of more points and is trying to estimate the delays along the way, to identify the best times to travel, and to find alternative routes that may be better (and perhaps more interesting and restful).

3. Or a traveler may want to know the radio stations in particular areas that broadcast news, traffic, weather, financial and commodity information, religious content, and their respective programming (for travel entertainment)

4. The queries are applied against the travel conditions and infrastructure segments of the system database which contain information such as:
Road construction (where, what, hours, extent, effects, typical delays), alternatives and trade-offs
Weather conditions and forecasts (via partnering sites) and travel effects
Closures, storm damage and effects and duration
Local fuel prices and general availability
Local regulations and customs affecting travel
Local media (radio, print, TV, roadside)
Public parking locations
Helpful hints, available options related to travel

The database queries generate reports back to the traveler/user.

The database includes:

5TC. Manual input of travel conditions, infrastructure data and other information to database by system personnel based on web searches

6TC. Manual input of travel conditions, infrastructure data and other information submitted to database by users after screening/edit by system personnel

7TC. Travel conditions, infrastructure data and other information from trolling by the system

8TC. Travel conditions, infrastructure data and other information submitted to the system database by government agencies and travel services and sources with local information

FIG. 5: General Description of Travel-Related Site Database. This figure describes the relational database 4TS travel-site content for travel destinations, the system's travel store, digital tours and video tours and their schedules and availability. It also illustrates the limitless range of keywords a user may use in an open-ended search (Inquiries 1, 2, 3) of all text provided by vendors, advertisers, services providers, and the invention operator. Site-related information and imagery, video and tours may be maintained in the invention's database 5TS, 6TS, 7TS, 8TS or at the vendor sites. The number and size of data elements for an individual site may depend upon the fees paid by the respective site, which of course will affect the advertising choices made by that site's operators or vendors.

The data records for each travel-related site will include the following types of information that describe the respective site:
Primary Record: Unique Identifier ID, Category ID, Attraction Type, Primary Accommodation Type, Restaurant Type, Travel Services Type, Personal Services Available, Store Type, Travel Access Method, Business/Site Name, Street Address, Town or City, State, Zip Code, Brief Description, Telephone, Fax, E-mail address, URL
Secondary description: Attraction Type—Secondary, if any, Unique Identifier ID, Fee or rate schedule, Special rate packages, Season(s) of Service, Hours of Operation, Weekdays, Saturday, Sundays, Dates closed, Special days closed, Special closures, Age Restrictions, Special Services (e.g., handicap access), Theme Tie-Ins, Photos, Digital Videos
The system gives site operators, advertisers, and vendors the flexibility to tailor database cells, contents and links to reflect whatever features and categories of information a respective site feels are appropriate to describe its uniqueness and appeal. Examples of some of the invention system search terms (which could be used in Boolean advanced searches—essentially any term or terms one might use in any Internet search) include (but of course are not limited to): Sports, Baseball, Football, Sailing, Skiing, Hiking, Tennis, Golf, Swimming, NASCAR, Cheap Eats, Upscale Restaurants, French Cuisine, German Food, Oktoberfest, Italian Food, Greek Food, Thai Food, Chinese Food, Middle Eastern Food, Afghan Food, Lebanese Food, National Parks, State Parks, Local/City/County Parks, Public Beaches, Street Fairs, Festivals, Art Shows, Art Galleries, Arts & Crafts, Theme Parks, Hot Air Ballooning, Tours, Particular artists or performers or shows, Traffic problems, Alternate routes and detours, Rush hours and times of congestion or construction, Road conditions, Weather, Handicap access, Special medical conditions, Days of operation, States, Cities, Campgrounds, Hotels, Motels, Chains, Chain stores (Ralph Lauren, Wal-Mart, etc.), Outlet Malls, Chambers of Commerce, Antiques, Flea Markets, Book Stores, 24-hour Care, Hospitals, Tourist Sites, Amusement Parks, Ethnic Associations, Churches, Veterinarians, Concerts, Performers, History, Civil War, Re-enactments, Re-enactors, Car Rentals, Airlines, B&Bs, Gardening, Orchids, Museums, Natural History, Science, Aerospace, Industry or a particular industry or type of business, Social History, Alcatraz, and so on.

The key is that the search terms are determined substantially by the user, tailored to his or her needs, preferences, whims, interests, and combinations. Likewise, the database is determined substantially by the words and terms and values and imagery and tour descriptions and other travel site related information provided by vendors, travel sites, and travel-related sites or by words and terms and values and information discovered by system personnel and trolling systems that find and introduce data and information and images into the database.

All travel sites and infrastructure services are identified with street address, fax number, phone numbers, e-mail address(es), GPS location, and icon indication type of site or service and proximity to and promotional tie-ins to other sites. The database also may include images and descriptions and pricing of items offered for sale by travel-related sites via this system's travel store. The database also may include digital tours and video tours and schedules and availability of virtual and in-person real tours (for current or advance booking by virtual travelers and for live in-person tours at travel sites).

FIG. 6: Search and Display Process. This figure illustrates the user's query of the system, the display of the query results, and options for storing the results and for viewing keyword-based opportunities that the system has identified as likely to be of interest to the user. The user's inputs 1 are matched 3 against the database 4, 4TC, 4A 4TS to produce the display 6. The proprietary directory and database include information and virtual and digital material and links provided by advertising or participating sites or tour providers or facilitators or compiled or developed or provided or operated by the database proprietor; maintained on proprietor's information systems and equipment and/or the information systems and equipment of the provider or facilitator.

The display 6 shows:
The results of the personal query or
The contents of a double-clicked travel folder or
The folders from the trip trunk or
The trips or tours or activities currently scheduled or other active, developing or recalled information.
Listings of paid advertisers and unpaid advertisers
Each item in the search results or folder contents or other individual items is listed with a thumbnail promotional image for the respective entry, a category icon or symbol, about 30 words of text related to the keyword basis for inclusion, and followed by the web url of the cited site.
Advertisers at the top of the page are included based on keywords and high-bid(s) for the respective keywords. Advertisers at the right side are the next lower bidders for the keywords and are mixed with randomly selected non-paying travel-related sites or advertisers.
Trip trunk(s), gamebox(es) and trip folder(s) are arrayed across the bottom of the display and are repositories for the selected sites or tours or games or lists under consideration and for scheduled activities.

Listed sites can be selected with an icon click and dragged or sent to a trip folder or gamebox or trunk or balled up and sent to the reject container. Scheduled activities are in a folder with a calendar on the front. The date and time on the calendar are highlighted to indicate a scheduled activity. Trunk(s), gamebox(es), folder(s), container(s) across the bottom of the display screen

FIG. 7: Looking for Possible Places to Go or Taking a Daydreaming Trip. This figure is similar to FIG. 3 except that it illustrates a less-structured search by a user for possible places to go or for the pursuit of a serendipitous daydream or virtual trip. The user 20 wants to identify places to visit or about which to daydream, and the respective sites. The user enters preferences 20 or applies previously identified preferences 2. The invention searches 3 those preferences against the invention's database 4 and returns the display of results 6. The user may store this list or selections from this list 5 or may reject 8 or defer 9 the individual items. The user also may proceed with the list, interactively applying judgments for selection and refinement based on criteria 11 and setting aside the possibilities with annotations in trip files 10 and moving ahead with those tentative choices 12 and interactively arranging the choices into a trial itinerary 13 with supplemental information drawn from the master file and links 19. The user then selects on-line visitation 21 and proceeds with a serendipitous, free-wheeling on-line exploration 22 (the sequence and contents can be saved in a trip file as a later basis for an actual trip or it can be deleted).

The sequence illustrated in FIG. 7 includes:

20. Looking at places to go or daydreaming about destinations and seeing sights; input/apply preferences and save to folder name for file.

3. Search for ideas by some category or particular place or interest, etc.

4. Searchable, stored information about travel sites and travel infrastructure

5. Selected sites of interest to the travel planner stored for later consideration

6. Display search results with paid ads at top and side and with special feature icons with each entry

7. Possibilities selected for consideration

8. Rejects

9. Deferrals

10. Possibilities set aside or tagged with interest/note or trip file name

11. Examples of Interactive Selection Refinement Criteria include:
Total time for trip
What to see/do at each site?
Features
Links to websites and paid ads
Access by car? train???
Time at each place?
Recommended?
Personal preference?
Preferences of others?
Places to eat/stay nearby?
Costs: see, eat, stay, travel

12. Tentative choices

13. Interactive arrangement of choices into trial itinerary with travel routes and time and allotted visit times—line-by-line and in calendar form

19. Supplemental information drawn from master file and links

21. Selection for on-line visitation

22. Serendipitous free-wheeling on-line exploration; (search trail stored or deleted)

FIG. 8: Arranging for and Taking a Virtual Tour. This figure starts with the same input inquiry process used in planning a trip (FIG. 3) but the objective is to identify virtual tour options, to make a selection, to make a reservation for later return or to take the tour immediately, and to spend time in the virtual tour and gaming lobby before taking the tour.

A user preferring to virtually tour a specific travel site or to virtually screen sites for a specific trip would input preferences and requirements with a trip name for the file or apply previously saved specifications 23. The invention matches 3 those specification and requirements against the database 4 and returns the display of the results 6. The user has the option of saving the list 5 or proceeding with choices 7 to reject 8 or to defer 9 or to set aside certain selections 10 or to proceed with tentative selections for a virtual tour 12. With the assistance of supplemental information 19, the user selects a tour 24 and, if it is available immediately, may tour on-line 25, paying for the tour if a fee is required 27 or proceeding with the tour if a fee is not required 28 and taking the virtual tour 33. If the tour is in the future and requires scheduling or reservation 26, the user enters the scheduling module, picks an available date and time 29, makes reservations through a complimentary e-service or directly and pays user via the invention's payment module 15. The invention generates a reservation confirmation and electronic ticket 30 and a reminder message with a countdown clock and name of the tour 30a which is placed on the user's electronic device. The user returns at the scheduled time with electronic ticket code 31 and enters the virtual tour lobby and chats or plays games or sees previews while waiting 32 to take the virtual tour 33.

Some tours will be offered free as a promotion or with paid advertising sponsorship.

FIG. 9: Virtual Tour (General Process). This figure shows the sequence of steps once the virtual tour has been selected. The tour may be in a variety of formats, which will be illustrated in FIG. 10. FIG. 9 also shows the option of the end of the tour to take a test for education credit after which the user exits the virtual tour.

After accessing the virtual tour 33, there are two options: The tour may have been downloaded to the user's own device or it may be conducted on the site's host or on the invention's server. If on the user's own device 36, the user selects and manipulates images from a menu, pans sites or rotates cameras and plays and replays video and audio on demand. For tours on the site's host or the invention's host 39, the user selects and manipulates images from an accompanying list and may participate in a live tour, which is described in FIG. 10. Following the tour there may be an option for taking a test for education credit 37, 40 or non-credit 37a, 40a followed by exit from the tour and test module 41.

Specifically, the illustrated sequence includes the following elements:

24. Tour Selected at Kiosk

25. Tour available now on-line

27. Pay for tour now with this system's payment module

28. Some tours will be offered free by site as promotion and others free but with paid advertising

33. Access virtual tour with partially interactive video and audio

35. Load and start tour file on own device or at site

34. Supplemental information, games, ads, drawn from master file and links

36. Activate tour on own device; select and manipulate images from accompanying list; replay video/audio on demand

37. Take test for education credit

37a. No test for education credit

38. Close tour and file self-destructs

39. Activate tour on site's host; select and manipulate images from accompanying list; replay video/audio on demand

40. Take test for education credit

40a. No test for education credit

41. Exit site; connection lost; or return to home page.

26. Tour requires scheduling or reservation

29. Enter scheduler module, pick available date and time

15. Make reservations through a complementary eService or directly and pay via this system's payment module

30. Reservation confirmed and electronic ticket generated

30a. Reminder messaging with countdown clock and name of tour

31. Return at scheduled time with electronic ticket code

32. Enter virtual tour lobby and chat or play games or see previews while waiting

34. Supplemental information, games, ads, drawn from master file and links

FIG. 10: Virtual Tour Option Illustrations. This figure shows a number of virtual tour formats, which are incorporated into the invention. These range from passive viewing of images with or without a narrative text or audio track through self-guided tour options to the most complex options which are guided live by a tour guide with varying degrees in interaction between the guide and the tour members and even among the tour members themselves.

The relatively passive option 10A involves accessing tour software and data and images via download or operating on a host site. The user reviews menu options and selects what to see and operates the imagery selection and pan-controls and makes audio choices. At the end of the tour, the user may take a test, if required or if desired and available. A less passive option adds hot buttons or hot spots over images that reveal themselves as the cursor passes over them; the spots may point to questions about the scene with answers that may be recited simultaneously via audio or simply revealed in text.

Access tour software, data and image/video files via download or operating on host site or on the remote travel site's server

Review menu options and select what to see

Operate the imagery selection and pan-controls and make audio choices, as available

Tap optional hot buttons or spots of images that reveal themselves as cursor passes over them OR point to questions about the scene that may also be recited when/as passed over by the cursor and illuminated and choose multiple choice answers

Continue to end or terminate

Take test if required or if desired and available

The next level 10B is a prepackaged video and audio system with some optional choices, which may be operated on a host site or a travel site's server or downloaded.

A self-guided tour 10C with fixed on-site cameras and accompanying audio is the next option.

A self guided, interactive tour with manipulable, mobile cameras 10D and audio system provides a more satisfying and sophisticated tour capability.

Access tour software, data, image/video files and on-site fixed cameras via download or operating on host site or on the remote travel site's server

Review menu options and select what to see; request/set subject and camera sequence or accept default order for subject/camera/audio

Operate the video and audio systems, zooming and panning the cameras

Tap hot buttons or spots of images that reveal themselves as cursor passes over them OR point to questions about the scene that may also be recited when/as passed over by the cursor and illuminated and choose multiple choice answers

Continue to end or terminate

Take test if required or if desired and available

A live, guided tour 10E with a guide and audio and WiFi-linked capabilities permits interactive involvement and communication between 10F tour members and the guide and even with each other.

Access tour software and test quality of imagery and audio; test microphone and camera for interaction with tour leader and tourmates

Participate in tour group introductions, if a group; OR meet the tour guide

Guide describes the tour with visuals and interaction

Guide then leads tour using mobile camera and microphone connected to portable or fixed location computer via WiFi, perhaps linked with or attached to headgear and with mini-viewing screen such as military pilots use; guide takes questions along the way

Continue to end or terminate

Take test if required or if desired and available

FIG. 10 merely illustrates the range of possible variations and applications for tours accessed and transmitted via the Internet or other electronic media that are envisioned in this current invention. Note also that all the illustrated tour options and others envisioned are connected via the system's tour office and scheduling module and are entered through the proprietary themed tour assembly/departure point/lobby which also is the game lobby.

FIG. 11: Game-Based Travel. This figure builds on the trip planning model but focuses on: the game preferences of the user; the purpose for the game activity (e.g., educational, pleasure, challenge); the user's abilities, scores, preferences and sophistication as revealed by intelligent system evaluation of the player; and the curriculum of the course or program specified by a participating school or university. Once the game has been selected, the process is similar to the selection, operation, and educational testing illustrated in FIGS. 9 and 10 for virtual tours.

The illustrated sequence in FIG. 11 includes the following elements:

1a. User entry of game-based entertainment or educational experience preferences (including availability of optional educational credits). May be identified by self or group or educational institution or teacher in catalog or curriculum. User inputs curriculum specifics or specific preferences and special requirements with trip or game folder name and personal name card.
2. User may apply preferences on file, if desired.
3. Search for ideas by some category or particular place or interest, etc.
4. Searchable, stored information about travel-related on-line games and their target characteristics and recommended ages for the respective travel sites and respective games.
5a. Selected sites/games of interest to the player(s) stored for later consideration
6. Display search results with paid ads at top and side and with special feature icons with each entry
7. Possibilities selected for current consideration

### 8. Rejects

### 9. Deferrals

10a. Possibilities set aside or tagged with interest/note or trip or game folder name and personal name card and stored in GameBox
11a. Examples of Interactive Selection Criteria include:
Type of action [e.g., knowledge-transfer, exploration (interactive), adventure (interactive), etc.]
What to see/do at each site?
Special Features
Game duration/save/store
Skill level required
Competitor(s)? (e.g., self, computer, others, teams, best score)
Approximate age range
Suitability; parental controls
Recommended?
Personal preference?
Preferences of others?
Curriculum specs or sequence or options
Number of players required or best
Scored?
Educational credit?
Credit toward fee-based games or toward reduced entry fees for actual visits to the respective site or package of sites.
   12a. User chooses to play now
   19a. Supplemental information (e.g., ads, options, enhancements, alternatives, info from respective site or other source) drawn from master file and links
   24a. Select Game or Activity
   25a. Game available now on-line
   27. Pay for game now with this system's payment module
   28a. Some games will be offered free by site as promotion and others free but with paid advertising
   33a. Play game with video and audio and interaction
   40b. Take test for academic credit following game
   40c. Receive test score live or on delayed basis
   43. Score/grade is entered on transcript or e-mailed to educator
   44. Game over; game player(s) returned to lobby for scores and further plays or access to other website pages
   42. Game score (if scored) identified and posted in gameroom lobby
   44. Game over; game player(s) returned to lobby for scores and further plays or access to other website pages
   26a. Game requires scheduling or reservation
   29. Enter scheduler module, pick available date and time
   15. Make reservations through complementary eService or direct and pay via this system's payment module for self (or group)
   30. Reservation confirmed and electronic ticket generated for self/group
   30a. Reminder messaging with countdown clock and name of game
   31. Return at scheduled time with electronic ticket code
   32a. Enter game room lobby and chat or play games or see previews while waiting or enter through an entertainment house (e.g., fun, horrors, etc.) or through theme park or arcade
   33a. Play game with video and audio and interaction
   40b. Take test for academic credit following game
   40c. Receive test score live or on delayed basis
   43. Score/grade is entered on transcript or e-mailed to educator
   44. Game over; game player(s) returned to lobby for scores and further plays or access to other website pages
   42. Game score (if scored) identified and posted in gameroom lobby
   44. Game over; game player(s) returned to lobby for scores and further plays or access to other website pages

FIG. 12: Scheduling Process and System. This figure illustrates the flow of the scheduling and reservation process and ticket issuance for on-site tours and admissions, virtual tours and games for individuals and self-identified groups.

The scheduling module will allow virtual travelers to open a calendar of available tour times by date for the tours of interest to them. The user will pick the date, then the time, and will enroll himself or herself (or a party of a few or many) for participation in the tour from a single location (generally, the PC or Mac or other electronic Internet-capable device from which enrollment is made) or multiple locations. The scheduling module will process the request and process the tour fees, if any, such as payments by credit card or electronic charge against a bank account or a charge against a credit balance on deposit in the user's account within the invention bank. After the charge is processed and accepted, the user will get a confirmation of the transaction and date and time together with an electronic ticket or receipt which will be used to access the tour at the scheduled time. The tour time may be rescheduled, given adequate advance notice.

The illustrated sequence includes the following elements:

29. User inputs tour, game, site visit date/time preferences with number in party or players. System interrogates relational database
4a. Proprietary relational database of sites, tours, games and all related details as well as many tours and games themselves.
29a&29b. Return to try another date/time or leave scheduling module
29c. Finalize arrangements
27. Pay through payment module, if fee is required, and receive confirmation and electronic ticket(s)
33a. Proceed to tour or game, if immediate
30a. Set alarm and e-mail reminders for return at scheduled time
28a. If no payment required, receive confirmation and electronic ticket(s)
33a. Proceed to tour or game, if immediate
30a. Set alarm and e-mail reminders for return at scheduled time
30. If scheduled reservation, paid or free, is for a site visit, receive confirmation and electronic ticket(s) for use on-site
30b. Save e-ticket(s) and reservation details in trip folder in trip-trunk
45. Return to scheduler for more scheduling or leave the scheduler module

FIG. 13: Banking/Payment Transaction Module. This figure shows the operation of the banking and payment transaction module within the invention. This module receives and verifies payments, credits those payments to the proper account, allows the user to proceed with the purchased service, releases any purchased goods, applies credits for discounts earned by the user, generates the accounting detail and Summary Reports for vendors and tour operators and advertisers, processes advertisers payments and charges, permits drawdown of excess credit balances in accounts, and advises account holders of credits earned by site visitors and promotional discounts issued. Advertisers and travel sites submit advertising fee payments and receive tour revenues, game revenues, game royalties, merchandise revenues, advance ticket sale revenues and other net revenues.

Each business account is backed by an activity ledger. The ledger identifies each activity and the current cumulative balance. Expenses are accumulated and charged against the site's deposit payment or a credit card on account. When the available deposit is less than a five-day average charge, the day's charges or a minimum amount to be determined will be drawn from the credit card or by electronic draft. A minimum deposit or available credit on a credit card is required. Credit-card draws, if necessary, by the invention operator may be made to maintain a minimum credit balance for advertising costs incurred by the respective site.

The vendor or advertising site will have access to its account for withdrawal of the available credit balance in excess of the required minimum for advertising expenses. The site also will be able to make deposits to its account in order that draws are not made on a credit card. Credit balances may be withdrawn at any time of any day. A complete, detailed report or transcript of account activity will be made available to the holder of the business account at any time.

User payments will be processed through the same system via a different module. Users and members may be able to make payments for fee-based uses, including tour fees and other charges that may arise. In the event that the invention operator provides a system for users and members to buy and sell new or used or surplus items (e.g., souvenirs from travels, camping equipment, unused bearer passes, or anything else), the user and member payment module may be adapted to process and serve as the medium for financial transactions between users.

Members/Users Transactions include:
Member fees paid in
Virtual tour fees paid in
Game fees paid in
Merchandise purchases paid in
Other expenditures paid via credit card or electronic funds transfer paid in
Credits or discounts earned (other than those provided directly by respective travel sites such as admission ticket discount coupons or special room rate discounts) are credited to the member/user account

Travel Site Bank Actions include:
Setting up accounts for users, members, vendors, site visits, tour operators, etc.
Processing user payments
Crediting user accounts
Maintains user account details, balances; providing real-time transaction summaries
Processing advertisers' payments on account
Processing advertising charges against accounts
Crediting accounts with admissions and user fees
Permitting draws of excess credit balances in accounts
Advising accountholder of credits earned by site visitors and promotional discounts issued (and related details) to facilitate identification of future liabilities

Advertisers & Travel Site Transactions may include:
Advertising fees—fixed & per click—paid in
Virtual tour revenues (less commission) credited to vendor account
Game revenues (less commission) credited to vendor account
Game royalties credited to vendor account
Merchandise revenues (less commission) credited to vendor account
Advance ticket revenues (less commission) credited to vendor account
Other service expenses and revenues credited to vendor account
Acknowledgement of credits and discounts issued by vendor via advisory communication
Reversal of transactions, if appropriate, charging vendor account
Recording of advance sale ticket numbers for control and confirmation at time of use (communicated to vendor)

Other logical services which may be added to the invention beyond those described above and illustrated in the 13 figures include:
Travel and accommodation options and reservations
A travel magazine (Travelogue)
Travel resources and reference materials and links
One or more forums and discussion facilities and blogs and trip-showcasing capabilities for users
Virtual sightseeing tours (for fee) analogous to bus tours where a guide leads the tour which spans more than one site and experts provide lectures during the travel time—in essence; armchair travel for people who do not want to make the physical trip or who are unable to travel but seek the opportunity, exposure and stimulation. This capability builds on the live-guide option discussed for FIG. 10 (see above).

What we claim as our invention is:

1. An Interactive, Internet-based system for trip planning, virtual travel, travel-based education, travel-related gaming and virtual and live touring, drawing on the invention's unique database of travel opportunities, gaming and educational opportunities, integrated travel resources and the system's user community, and virtual and live tour opportunities, the system comprising:
An operations facility of servers and database storage facilities which are the platform upon which the related methods and processes of the invention and its programs reside and operate,
Additional computers within the operations facility for the management and supporting activities to establish and maintain the invention,
Said activities including ongoing programming, testing, and improvement of the invention's software,
Said software providing modules for the input, verification, and storage of the invention's database,
Said software also providing modules for input and processing of invention-user specifications of preferences, interests, special needs, and other parameters,
Said software also providing modules for the matching of the user inputs to the database and for the retrieval of matching hits for further consideration, filtering, screening, and selection or rejection or deferral in the planning of a trip, planning and experiencing virtual travel, the pursuit of travel-based education opportunities, participation in travel-related games, and visits to remote sites via virtual and live tours,
Said software also providing modules for receipt, storage, retrieval, and operation of vendor-provided games, tours, virtual- and live-tour links, and site-descriptive material and advertising,
Said software also providing modules for scheduling tours and game opportunities and issuing virtual tickets either free or for payment,
Said software also providing modules for collecting virtual tickets and admitting ticket holders to scheduled tour and gaming opportunities,
Said software also providing modules for testing user knowledge after a tour or gaming opportunity for educational credit,
Said software also providing modules for receipt, deposit, and posting of revenues to the respective vendor accounts,
Said software also providing modules for vendor withdrawal of credit balances and vendor deposit of payments for the invention's advertising services,
Said software also providing modules that establish and operate a “lobby” which serves as a gathering place for people and groups about to take a tour and for people who wish to participate in gaming and educational opportunities,
Users' sites which may consist of some or all of the following components,
Personal computing device with keyboard and monitor and hard drive storage space,
A printer
A modem hard-wired or with WiFi or dial-up, satellite, cable or DSL connection to the Internet,
And other remote devices such as cell phones, PDAs, Blackberry-type systems, WiFi networking connected devices, and vehicle on-board direction and mapping systems
Vendors' sites which may consist of:
Personal computing device with keyboard and monitor and hard drive storage space,
A printer,
Mixed-media, creative, interactive facilities for preparation and presentation of passive tours, for self-directed tours using cameras and audio recordings provided on or by the vendor site, for live tours which are conducted by an on-site guide (with varying capabilities for interaction between the guide and the tour members and among the tour group members),
High speed Internet-access necessary for transfer of the live tour, passive tour, and advertising to the current invention's facility for transfer to users or for storage.

2. The system in claim 1, wherein methods and processes provide for planning of a specific trip, the methods and processes comprising the steps and processes of:
The user providing input of specific preferences and special requirements for a particular trip and assigning a trip name to the file
Alternatively the user applying preferences already on file, if desired
The invention's operations facility matches the users inputs against its searchable, stored information about travel sites and travel infrastructure
The invention's facility retrieves and displays the matches for user consideration and action
The user selects and stores sites of interest on the invention's server from the displayed matches
The user selects or rejects or defers items from the displayed search results in the course of planning a trip
The search result display also includes advertising for consideration by the user
The user rejects items into a trash receptacle or defers by placing them on a shelf or in a trunk or save them by placing them in a trip file folder
The user performs active selection and refinement of a trip candidate components based on considerations of total time available, what to see and do at each site and the time it will require, and the site's hours of operation and operating days/dates, special features of the site, nearby attractions, and confirmation that the site meets the special needs and interests of each of the travelers
The user further winnows the remaining listed sites, either tagging possibilities as tentatively chosen or rejected or set aside with a notation for further consideration within a trip file name folder
The user's interactive arrangement of tentative choices into a trial itinerary with trial routes and time requirements and allotted visit times, displayed both line by line and in calendar form
Automated assistance with trial route identification, optimization, personalization, travel-time calculations and adjustment for driving considerations include an time-of-day, day-of-week, roadwork, and other factors
Automated conversion of the planned itinerary into a digital book with all details, maps, brochures, images and video as well as reservations made through complementary eServices or directly with sites, hotels, transportation carrier, and restaurants or via Internet-based travel services and sites
Integration of supplemental information drawn from the master file and all related links to fill out the itinerary book
Output of the final trip in paper or electronic form or as a download to a PC or PDA or cell phones or other electronic devices

3. The system in claim 1, wherein methods and processes provide for compilation, presentation, and provision of information on highway and travel conditions provided by manual, automated or external identification and input of travel conditions, infrastructure data and other information to the database by invention operating personnel or based on a web searches or external submissions for inclusion, the method and processes comprising the steps and processes of:
Manual input of comparable information submitted to the database by users, after screening/edit by operating personnel
Automated input of travel conditions and infrastructure data and other information obtained by system trolling
Information obtained on travel conditions and infrastructure information submitted to the system database by government agencies and travel services and sources of local information
The preceding inputs are aggregated into a database of road construction information, local weather conditions and forecasts and travel effects, road and transportation enclosures, storm damage and its effects and duration, state and local traffic laws and regulations and customs that affect travel; local media for entertainment and travel information; public parking information; and helpful hints and available options related to travel
Query capabilities for travelers to access the condition information
Query capabilities for travelers to estimate the travel time and delays along a particular route, to identify the best times to travel, and to find alternative routes that may be more appealing and restful to the travelers
Query capabilities for travelers to identify radio and television stations in the areas through which they will travel, identifying programming alternatives, sources of traffic information, and local programming
Keyword, category, and other query capabilities for specific routes and areas

4. The system in claim 1, wherein the methods and processes provide for the development, maintenance and expansion of an open-ended, relational database with a basic structure to ensure certain minimal content but beyond which the content and its value to searchers are a function of the words, text, images, games, and experiences that are provided to describe the sites, services, games, experiences, tours, features and characteristics in ways to appeal to the invention's users, maximize the match possibilities, and serve the provider's objectives, the methods and processes comprising the steps and processes of:
Vendors and advertisers providing information and imagery and tour and game files and interactive services to the relational database
The invention operator adapting category names to the types of sites, tours, games, user needs, and travel experiences sought by users and considered appropriate by vendors and advertisers.
The automated tracking and analysis of search terms and keywords applied by users to determine the frequency of use and the hit-to-search relationships and other analytic and anecdotal information for use in refining the database and the methods and processes for user search and access and search results presentation.

5. The system in claim 1, wherein methods and processes provide for searching and displaying and grouping information drawn from the invention's unique database, the methods and processes comprising the steps and processes of:
Using search terms or preferences identified by the users and optionally stored on the invention system for present or future use
Querying the proprietary open-structured, relational database of travel-related sites and virtual information
Said database and directory including vendor and system personnel-inputted information as well as virtual digital material or links provided by advertisers or tour providers or facilitators, or compiled, developed, provided or operated by the database operator
Said material maintained on the invention operator's information systems and equipment and/or the information systems and equipment of the provider or facilitator.
Said computer display showing:
The results of the user's personal query
The contents of a double-clicked travel folder previously filled
The folders and items within a trip trunk
The trips or tour or activities currently scheduled or other active, developing or recalled information and links to listings of paid advertisers and unpaid advertisers
The matched items resulting from a user query
Said items displayed individually with a thumbnail for respective entry, a category icon or symbol, about 30 words of text related to the keyword basis for inclusion, promotional linkage, and followed by the Web URL of the cited site
Advertising across the top, bottom and down the side or elsewhere on the display. Presentation of the ads may be in randomized combinations of non- or lesser-fee advertising along with top-fee paid advertising or preset ads on each search page with the displayed ads selected from the applicable categories based on algorithms favoring the higher priced advertising but ensuring exposure to the lower-priced advertisements, all selected based on keyword match.
Trip trunks, game boxes, and trip folders are arrayed across the bottom of the display and are active repositories for selected sites, tours, games or listings which are under consideration and for scheduled activities and reservations
Scheduled activities are filed in a desktop folder with a calendar on the front with the individual date and time highlighted on the calendar to indicate a scheduled activity

6. The system in claim 1, wherein methods and processes provide trip planning through the methods and processes as described for claim 2 but with a less-structured search for possible places to go or for pursuit of a daydreaming trip without specific initial destination(s), instead leaving the trip's itinerary and content to serendipitous development, and allowing user selection of options for whimsical and spur-of-the-moment, on-line visitations to site(s) of interest and serendipitous, free-wheeling on-line exploration; (the search trail can be automatically stored for later return or for conversion to a tentative planned itinerary or optionally deleted)

7. The system in claim 1, wherein methods and processes provide for arranging for and taking a virtual tour, the methods and processes comprising the steps and processes of:
The user's inputs of specific interests, preferences and special requirements for tours
The invention matches the query against its database of available tours and returns a listing of the candidate matches
User selects sites of interest for later consideration or proceeds with review of tour summaries and perhaps paid-ad sites that are simultaneously displayed
Possibilities are selected by user for consideration or deferred or rejected
Each possibility that is set aside (deferred) may be tagged with a note and filed under a trip name or subject theme
User can continue with the tentative choices of virtual tours or call up previously set-aside tour choices and select a tour
User may take a tour now if it is available on-line at the moment
User pays for the tour now with the invention's payment module or takes a free tour, if offered by a site free of charge and with or without paid advertising exposure
User takes a virtual tour with still images or with video and audio and exits when the tour is over
Alternatively the user schedules a future tour and makes the reservation, entering the scheduler module, then picking a suitable available date and time, making a reservation through complementary e-service or directly and paying through the invention's payment module
Reservation is confirmed and an electronic ticket is generated
Reminder message with a countdown clock and name of the tour is generated and installed on the user's device
User returns at the scheduled time with electronic ticket
User enters a virtual tour lobby and chats with other tour takers or plays games or sees previews and ads while waiting for the tour
User may access virtual tour with partially interactive imagery, video and audio
Load and start tour file on own device or at vendor site and run on device, select and manipulate images from the accompanying list and replay video and audio on demand
If activating tour on site's host, select and manipulate images from accompanying list and replay video and audio on demand
Take optional test for educational credit
Close tour file when finished and files, if downloaded, will self-destruct
If on vendor or invention server, exit site, connection is lost and user is returned to home page
Virtual tours include numerous types:
Fixed or pannable still images (optionally with menus for user selection) which may also have audio tied to the images and may reside on a host site or a remote travel site's server or may be downloaded—the user operates imagery selection and pan-controls and makes audio choices
Fixed or pannable images with point and click and hot spot capabilities with optional audio system on host site or on remote travel site's server or may be downloaded—the user operates imagery selection and pan-controls and makes audio choices and has the option of clicking on hot spots of the images that reveal themselves as the cursor passes over them or can point to questions about the scene that may also be recited when/as passed over by the cursor and answered; user may have the option of choosing multiple choice answers
Pre-packaged video and audio system with optional menu system on host site or on remote travel site's server or possibly may be downloaded—user operates the video and audio systems with menu choices, if available
Self-guided, using fixed cameras and audio system with optional menu system on host site or on remote travel site's server or partially downloaded—user reviews menu of options and selects what to see, requests and sequences camera and subjects or accepts default order for subject/camera/audio; user operates the video and audio systems and makes choices, including hot spot options for additional information or questions and answers possibly followed by multiple choice testing at the end of the tour
Self-guided, using interactive, manipulable, zoomable cameras and audio system with optional menu system on host site or on remote travel site's server or possibly downloaded
Live, guided tour with guide and audio and microphones and mouse for personal or self-arranged group joining from the same or multiple sites with tour guide presenting illustrated introductory presentation and the tour with ongoing Q&A and interaction with tour members—user participates in tour introductions if touring in a group or just meets the tour guide, if alone; the guide describes the tour with visuals and interaction; guide then leads the tour using mobile camera and microphone connected to a local site computer via WiFi and perhaps using an optional communications unit with a head gear camera, microphone and earphones
Live, guided tour with guide and audio and microphones and mouse for personal or self-arranged group joining from the same or multiple sites with tour guide presenting illustrated introductory presentation and the tour with ongoing Q&A and interaction with tour members—user participates in tour introductions if touring in a group or just meets the tour guide, if alone; the guide describes the tour with visuals and interaction; guide then leads the tour using mobile camera and microphone connected to a local site computer via WiFi and perhaps using an optional communications unit with a head gear camera, microphone and earphones; guide takes questions along the way
All of the various tour formats are accessed via the Internet or other electronic channels and connect to all tours via the invention's tour selection and scheduling module and the tour assembly/departure point lobby

8. The system in claim 1, wherein methods and processes provide for identification and selection of game-based travel and travel-based gaming opportunities, applying the selection method used for trip planning and tour identification and selection, the methods and processes comprising the steps and processes of:
User identifies the subject or educational experience preferred
The invention also matches the user with previous performance and experiences and choices made
Optionally, the invention matches the user to educational institutions or teachers or curricula for identification of game and educational material and testing that is specified
System applies user's inputs and searches for games by category or subject or place or other input or educational requirements, matching against the invention's database
User selects sites and games of interest and stores for later consideration or proceeds with the selection, rejection, deferral process, applying interactive selection criteria such as types of action, what to see see/do at the site, special features, game duration and ability to save a game in progress or store results, skill level required, competitive circumstances (e.g., against self, computer, others, teams, best score), age range, recommended age group, parental controls/recommendations, personal preferences, group preferences, core curriculum specifications or game sequence or options, number of players required, availability of educational credit, possibility of credit toward fee-based games or toward reduced entry fees for actual visits to the respective site or packages sites, and so on.
User selects game to play now or later
For game available now on-line, pay for a game now with the invention's payment module (some games will be offered free by the site as a promotion and others may be free but with paid advertising exposure)
Plays a game with video and audio and interaction
May take test for academic credit following the game, receive test score live or on a delayed basis; score generated is entered on transcript or e-mailed to educator and game is over; game player returns to lobby for scores or re-testing or to play more games or access to other web site pages
If game requires scheduling and a reservation, or rescheduling, user goes to scheduling module, picks available date and time preferred
Makes reservations through complementary eService or direct and pays through the invention's payment module for self or for group
Reservation is confirmed and an electronic ticket is generated for self or for the group
Reminder message is generated with countdown clock and the name of the game and is placed on user's device and those of the rest of a group, if any
Individual or group returns at the scheduled time with electronic ticket code for admission
Enters the game room lobby and chats or play games or see previews and ads while waiting and then enters game through an entertainment house (e.g., fun, hall of horrors) or through theme-park or arcade

9. The system in claim 1, wherein methods and processes provide for scheduling tours, games, site visits and obtaining tickets, the methods and processes comprising the steps and processes of:
User input of tour, game, site or site visit date/time preferences with number in party or number of players
System interrogates relational database for matches in proprietary relational database which includes sites, tours, games and all respective related details and descriptions as well as many of the actual tours and games
User determines the date and time preferred
Invention identifies whether the time and date are available for the number of participants to be scheduled
For mutually acceptable date and time, arrangements are finalized and payment is made through the invention's payment module, if a fee is required, and an electronic confirmation and electronic ticket are generated after payment is processed and the vendor site is notified; if no payment is required, a confirmation and electronic ticket are generated; if the scheduled reservation, either paid or free, is for a site visit, confirmation and an electronic ticket are generated for use on-site
User proceeds to the tour or game, if immediate, or an alarm is set and placed on user's device and e-mail reminders are sent for return at the scheduled time
For on-site visit, user saves E-ticket and reservation details in a trip folder or trip trunk and returns to the scheduler or leaves the scheduler module

10. The system in claim 1, wherein methods and processes provide for accepting and processing payment for the accounts of users and vendors at the invention bank and for accumulating the net balances and transaction details for reporting to users, members, vendors, site visitors, tour operators and so on, and for processing advertiser and travel site transactions and payments, the methods and processes comprising the steps and processes of:
Users may pay membership fees, virtual tour fees, game fees, and for merchandise purchases and may earn credits or discounts (other than those provided directly by respective travel sites) such as admission ticket discount coupons or special room rate discounts or tie-in discounts
Accounts are set up for each user, member, the vendor, travel site, advertiser, and tour operator and so on
Invention bank processes user payments and credits the appropriate vendor account and issues ticket or user authorizations
Bank maintains user and vendor account details and balances and provides real-time transaction summary and details on demand
Bank processes advertisers' payments on account and processes advertising charges against account balance
Bank credits vendor accounts with admissions and user fees
Bank permits draws against credit balances in account
Bank advises account holders of credits earned by site visitors and promotional discounts issued (and related details) to facilitate the identification of future liabilities
Advertisers incur advertising fees on fixed price or per-click price, which is determined from flat rate schedule or by auction
Sites with tours are credited with tour revenues minus the commission payable to the invention operator
Sites and vendors offering games receive revenues minus the commission payable to the invention operator
In instances where the game is operated on the invention server, the bank tracks and credits the game royalties to the game's intellectual property owner
The bank tracks merchandise revenues and credits them to the seller's account minus the commission payable to the invention operator
The bank tracks advance ticket sales revenues and advises the site or operator of the sales revenues and scheduled details and credits the operators account for those revenues minus the commission payable to the invention operator
Vendor sites provide an acknowledgement of credits and discounts issued by the invention operator
The bank reconciles its records, reverses transactions if appropriate, and records and reports advance e-ticket sales and ticket numbers to the respective site/vendor for control and confirmation by the vendor at time of use
